(19) United States
(12) Patent Application Publication
(10) Pub. No.: US 2008/0109721 A1
(43) Pub. Date: May 8, 2008

(54) Input device using slides and clicks and method thereof

(75) Inventors: Yi-Chun Liao, Taijhong City (TW); Cheng-Hung Chiang, Keelung (TW)

Correspondence Address: BIRCH STEWART KOLASCH & BIRCH, PO BOX 747, FALLS CHURCH, VA, 22040-0747, US

(73) Assignee: Mitac Technology Corp.

(21) Appl. No.: 11/593,561

(22) Filed: Nov. 7, 2006

(51) Int. Cl. G06F 17/00

(52) U.S. Cl. 715/702

(57) ABSTRACT

An input device using slides and clicks and a method thereof are provided. A first table of M×N larger than a display region is produced on an electronic device having the display region and an input region, a character set corresponding to the input language is allocated in the first table, and the display region is defined to display a second table of M1×N1 (M>M1, and N>N1), then a track is lined out on the input region to input a move signal, such that the first table makes a displacement based on the move signal. Then, the part of M1×N1 of the first table is displayed in the second table of the display region. When a select signal is input on the input region in the manner of click, a character corresponding to a field in the second table is input based on the input select signal.

### BACKGROUND OF THE INVENTION

1. Field of Invention

The present invention relates to an input device and a method thereof, and more particularly to an input device using slides and clicks and a method thereof.

2. Related Art

There are many types of input methods, and most of the current input methods are the conventional input method using a keys, wherein a keyboard is required in inputting by keys. The keyboard is classified into two types, one is a multi-key keyboard, and the other is a less-key keyboard. The multi-key keyboard such as a keyboard used together with an ordinary computer usually has more than 50 keys. Although more keys can be used in the input method requiring less key presses, the allocation region of the keys needs a considerable area, thus having the problem of being inconvenient to be taken along or having too small area of the key to use conveniently. The less-key keyboard usually has less than 20 keys, and is always allocated on a portable electronic device. Although it is convenient to be taken along, the problem that more key presses are needed when inputting a character, especially when the characters conforming to the condition input by the user is more than one, the user has to press the direction key again and again to move the cursor to the character to be input in the candidate character list and then input the character. Furthermore, the input methods used thereon are various, once the electronic device is replaced, the problem of using different input methods occurs, thus the user has to accommodate himself to a new input method.

In order to solve the problem of the inconvenience input by using a multi-key keyboard or a less-key keyboard, other input methods can be found on some of the electronic devices such as a tabular click input. Although the tabular click input method solves the above problems at the same time, and also has the advantages of using the input method having less key presses, and having a small input region which is convenient to be taken along, but is limited by the size of the display region. That is, since the tabular click input method needs to display a complete multi-key keyboard 111 on a display region 110, as shown in FIG. 1, if the multi-key keyboard 111 is displayed on a portable electronic device 100 having a small display region 110, the displayed keys must be zoomed down until the multi-key keyboard 111 is displayed completely, as such, the problem of being difficult to identify and click occurs.

Therefore, how to make the displayed keys be easily identified and clicked when a tabular click input is used has become an urgent problem to be settled.

### SUMMARY OF THE INVENTION

In view of the above problems, the main objective of the present invention is to provide a multi-key keyboard capable of making a displacement to be displayed as a table after the user lines out a track on an input region, and a part of the table representing the multi-key keyboard is displayed on a display region, such that the keys are easy to be identified and clicked. When the user inputs a select signal on an input region in the manner of clicking the data to be input, and finally the data corresponding to the field in the sub-table is input based on the input select signal, the displayed keys are easy to be identified and clicked when using a tabular click input, thereby solving the problems existing in the prior art.

In view of the above, the present invention is achieved by a device and a method thereof, and the device disclosed in the present invention comprises a processor, a memory, an input device, and a display device. The method disclosed by the present invention comprises first providing a table of M×N larger than the display region and allocating a character set corresponding to the input language, defining the display region to display the part of M1×N1 of the table (M is larger than M1, and N is larger than N1), then inputting a move signal, displacing the table of M×N based on the move signal, and displaying the sub-table M1×N1 in the table of M×N, and finally inputting the select signal, and inputting a character corresponding to one of the fields in the sub-table of M1×N1 based on the select signal.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a conventional tabular click input keyboard displayed on a display region;

FIG. 2 is an architectural view of an input device using slides and clicks according to the present invention;

FIG. 3 is a flow chart of the input method using slides and clicks according to the present invention;

FIG. 4A is a 10×4 table for a phonetic input according to the first embodiment of the present invention;

FIG. 4B is a 10×4 table for an alphanumeric input according to the first embodiment of the present invention;

FIG. 5A is a 6×2 table displayed on the display region according to the first embodiment of the present invention;

FIG. 5B is a 5×2 table displayed on the display region after the column number is reduced according to the first embodiment of the present invention;

FIG. 5C is a 6×3 table displayed on the display region after the column number is increased according to the first embodiment of the present invention;

FIG. 6A is a 6×2 table displayed on the display region after a displacement of one row vertically is made according to the first embodiment of the present invention;

FIG. 6B is a 6×2 table displayed on the display region after a displacement of four columns is made horizontally according to the first embodiment of the present invention;

FIG. 6C is a 6×2 table circularly displayed on the display region after a horizontal displacement is made according to the first embodiment of the present invention;

FIG. 6D is a 6×2 table circularly displayed on the display region after a vertical displacement is made according to the first embodiment of the present invention;

FIG. 6E is a 6×2 table displayed on the display region after a horizontal displacement is made according to the first embodiment of the present invention;

FIG. 6F is a 6×2 table displayed on the display region after a vertical displacement is made according to the first embodiment of the present invention; and

FIG. 7 is a schematic view of a mobile phone according to the second embodiment of the present invention.

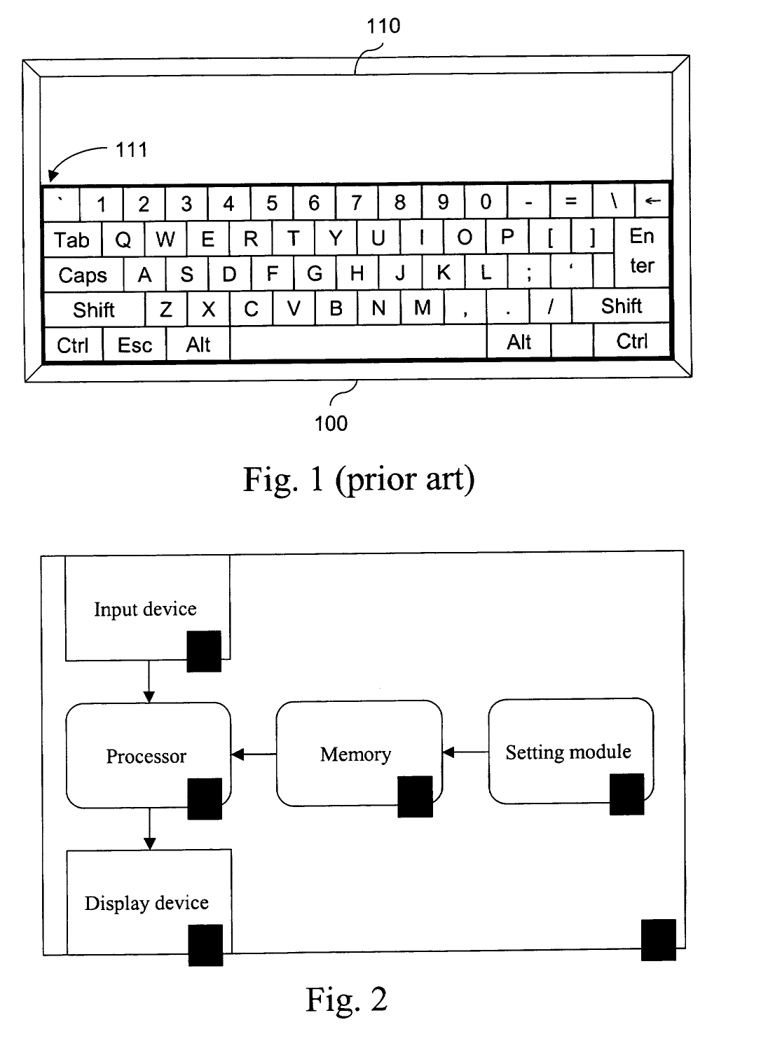

### DETAILED DESCRIPTION OF THE INVENTION

The operation of the present invention is firstly illustrated with reference to FIG. 2 as below, which is an architectural view of an input device using slides and clicks according to the present invention. As shown in the figure, the device of the present invention includes a memory 210, a processor 220, an input device 230, and a display device 240. The memory 210 is coupled with the processor 220 for producing a first table of M×N larger than the display region contained in the display module 240, wherein the first table is allocated with a character set corresponding to the input language. The processor 220 is coupled with the memory 210, the input device 230 and the display device 240, for defining the display region of the display device 240 to display a second table of M1×N1, wherein M is larger than M1 and N is larger than N1. After a move signal input by the input device 230 is received, the first table in the memory 210 is displaced based on the input move signal, and the part of M1×N1 in the first table in the memory 210 is read at a specific location. When a select signal input by the input device 230 is received, the character corresponding to a field in the second table displayed by the display device 240 is input based on the select signal. The input device 230 is coupled with the processor 220, which includes an input region and is provided to the user for inputting a move signal and a select signal and transmitting them to the processor 220. The display device 240 is coupled with the processor 220, which includes a display region and is used for receiving the second table transmitted by the processor 220 and displaying the part of M1×N1 in the first table on the second table in the display region.

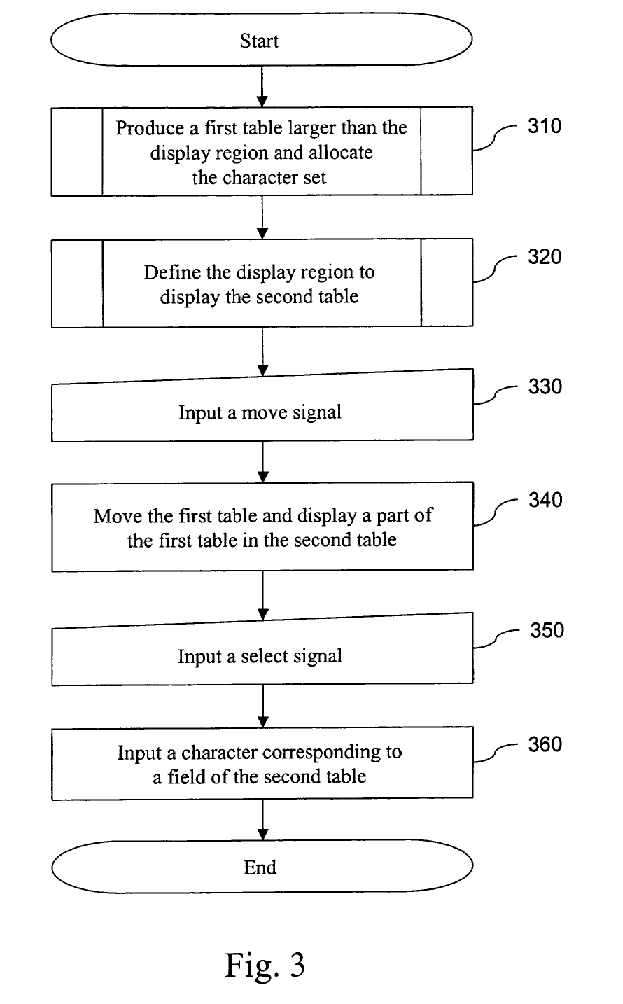

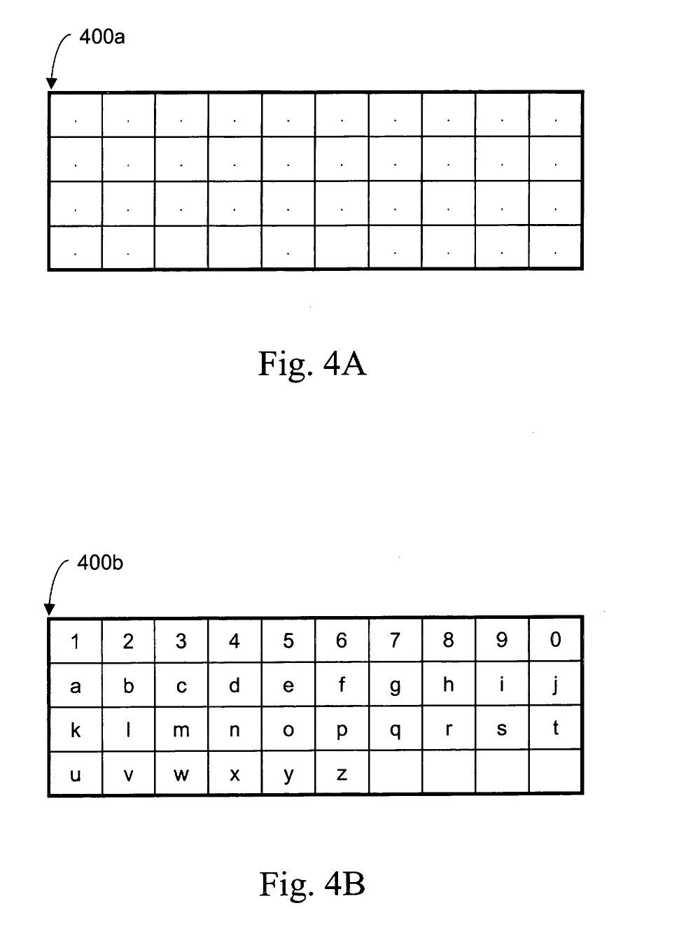

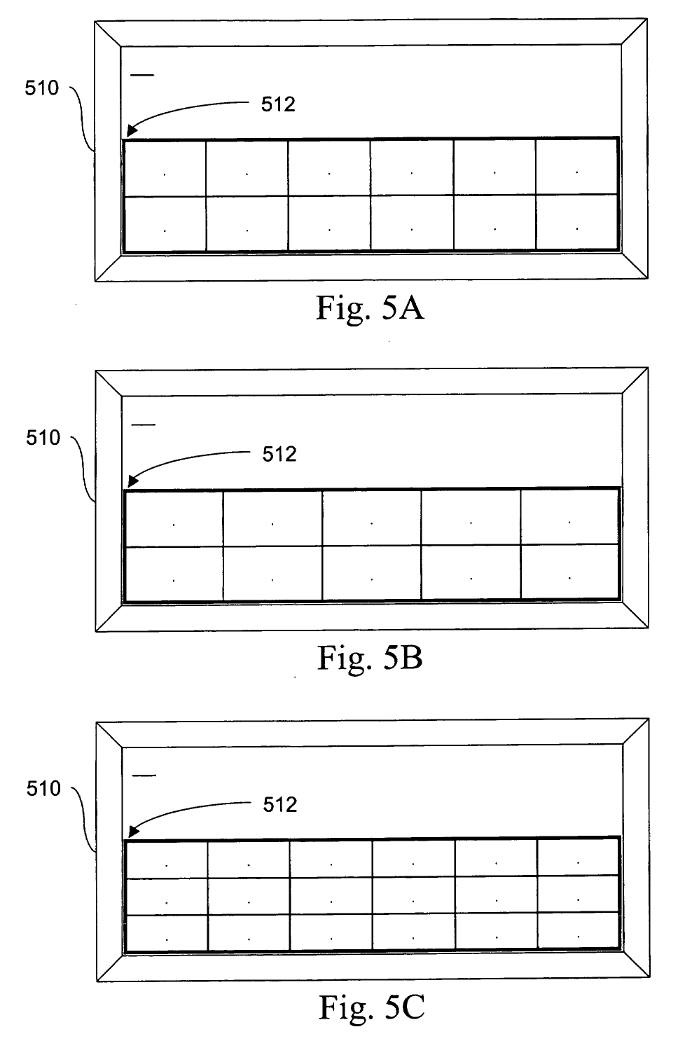

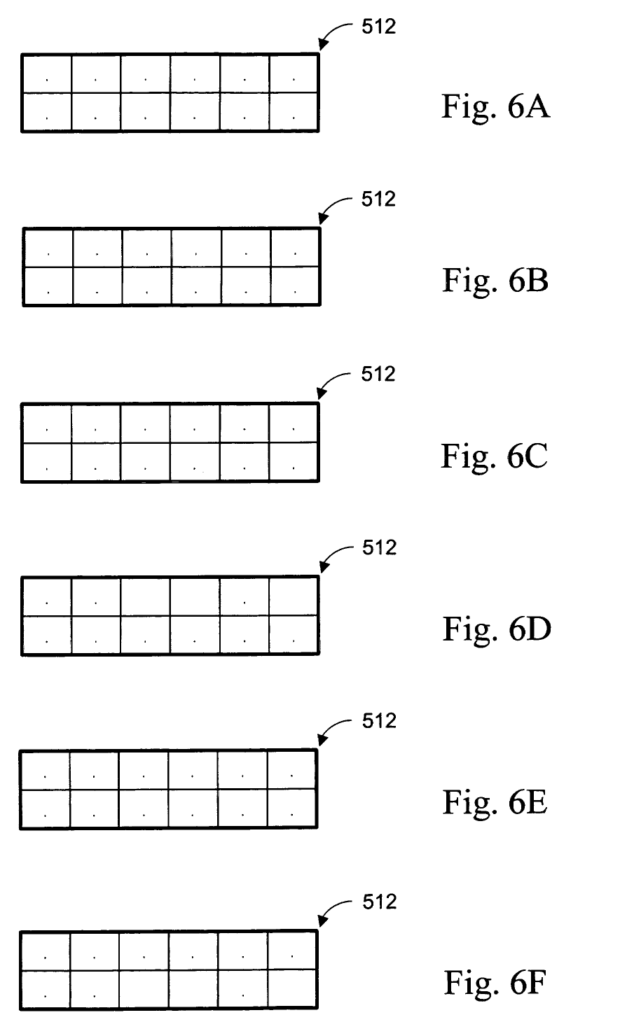

The operation and method of the device of the present invention is illustrated with reference to the first embodiment and FIG. 3, wherein FIG. 3 is a flow chart of the input method using slides and clicks according to the present invention. The electronic device mentioned in the present invention includes, but not limited to, a personal digital assistant (PDA), and a mobile phone. The input device mentioned in the present invention includes, but not limited to, a touch PAD, and a touch screen. The electronic device 200 in the present embodiment takes the PDA having a touch screen 510 as an example, as shown in FIG. 4A, when the user intends to use the present invention to input a Chinese character “□” by a phonetic method, the PDA first produces a table 400a of 10×4 in the memory 210 and allocate a standard phonetic symbol table (a character set) in the table 400a (Step 310). The PDA provides the table 400a of 10×4 to the user as a multi-key keyboard for inputting, then the processor 220 in the PDA defines the display region on the touch screen 510 to display a table 512 of 6×2 (Step 320), as shown in FIG. 5A. Now the user must input a sound of “□”, but the table 512 of 6×2 displayed on the touch screen 510 does not have the character “□”, however, the user knows that the table 400a of 10×4 produced in the memory 210 is arranged according to the standard punctuation mark table, so the character “□” is below the character “□”, thus a track is lined out downwards on the touch screen 510 by the finger to input a move signal (Step 330). When the processor 220 receives the downward move signal, the table 400a of 10×4 in the memory 210 is displaced upward, such that the table 512 of 6×2 displayed on the touch screen 510 seems to make a displacement in the input direction of the user, i.e. downward, by a predetermined row number (Step 340). For example, a displacement of one row is made as shown in FIG. 6A, at this time, the character “□” to be input by the user appears in the table 512 of 6×2 displayed on the touch screen 510, thus the user can input the select signal by clicking the field (key) of the displayed character “□” in the displayed table 512 of 6×2 (Step 350). After the processor 220 receives the select signal of selecting the character “□”, the character “□” is input to the phonetic input method on the PDA (Step 360).

Then the user intends to input “□”, as described in the above steps, the user knows that the character “□” is at the right side of the table 512 of 6×2 displayed on the touch screen 510, thus a track is lined out rightwards on the display region of the touch screen 510 by the finger to input a move signal (Step 330). When the processor 220 receives the rightward move signal, the table 400a of 10×4 in the memory 210 is displaced leftward, such that the table 512 of 6×2 displayed on the touch screen 510 is displaced by a predetermined column number rightwards (Step 340). For example, a displacement of four columns is made as shown in FIG. 6B, such that the character “□” appears in the table 512 of 6×2 displayed on the touch screen 510, thus the user can input the select signal by clicking the field (key) of the character “□” on the touch screen 510 (Step 350). After the processor 220 receives the select signal of selecting the character “□”, the “□” is input to the phonetic input method on the PDA (Step 360), thus the phonetic input method on the PDA will list all Chinese characters sounded “□□” for being selected by the user as the conventional input method of keys. The user may also line out an inclined track, after the processor 220 receives an inclined move signal, the inclined move signal is discomposed into a horizontal move signal and a vertical move signal, and the table 400a is displaced according to the horizontal and vertical move signals Since only a part of the table 400a of 10×4 is displayed on the touch screen 510, compared with the tabular click input mentioned in the prior art which needs to display a complete table of 10×4, the key (each field of the table) displayed by the present invention is obviously larger than that in the prior art. Therefore, the present invention which also uses the tabular click input can solve the problem in the prior art of being difficult to identify and click the displayed key.

If the user is not satisfied with the size of the key displayed by the present invention, for example the user still considers the displayed key is too small, the present invention enables the user to voluntarily set the column and row numbers of the table 512 displayed on the touch screen 510. The user may change the column number of the table 512 from 6 to 5, as shown in FIG. 5B, otherwise, the user may change the row number of the table 512 from 2 to 3, as shown in FIG. 5C. Of course, the column number and the row number also can be changed by the user at the same time.

Moreover, in order to facilitate the user to input, the present invention provides a circular display method, that is, when the keyboard is displaced by the user to the edge of the table 400a of 10×4, the fields on the other edge are continuously displayed on the table 512. As shown in FIG. 6A, when the displayed content of the table 512 is at the most right side of the table 400a, and when the user still inputs a rightward move signal, the table 512 still makes a rightward displacement by a predetermined column number 4. As shown in FIG. 6C, the two rows at the left side of the table 512 display the two rows at the most right side of the table 400a, and the right side of the table 512 displays the four rows at the most left side of the table 400a, so as to accomplish a circular display. The same situation will also occur when the user inputs a leftward, upward, or downward move signal. For example, after a move signal of an upward displacement is input in FIG. 5A, the table 512 displays the lowest column of the table 400a in the upper column, and displays the uppermost column of the table 400a in the lower column, as shown in FIG. 6D. Thus, even if the user is not clear about the location of the key allocation, the key to be input still can be found in a circular way.

Moreover, the present invention can further change the predetermined column number or predetermined row number of the displacement of the table 400a after the move signal is input. If the user changes the predetermined column number of the horizontal displacement from 4 to 2, when the user inputs a rightward move signal in the table 512 as in FIG. 5A, the table 512 will makes a rightward displacement by two columns as shown in FIG. 6E. If the user changes the predetermined row number of the vertical displacement from 1 to 2, when the user inputs a downward move signal, the table 512 makes a downward displacement by two rows, for example, FIG. 5A is displayed as FIG. 6F. The present invention also can determine the predetermined column number and predetermined row number of the displacement of the table 400a by the track length lined out by the user, for example, when the finger of the user moves from the character “□” shown in FIG. 5A to the character “□” (i.e. the lined out track passes through 4 fields), the processor 220 determines that the table 400a is displaced horizontally by 4 columns, as shown in FIG. 6B. When the finger of the user displaces the character “□” shown in FIG. 5A upwards to exceed the field thereof, the processor 220 determines that the table 400a is needed to make an upward displacement by one row, as shown in FIG. 6D. As such, it may be more convenient for the user to move the table 400a.

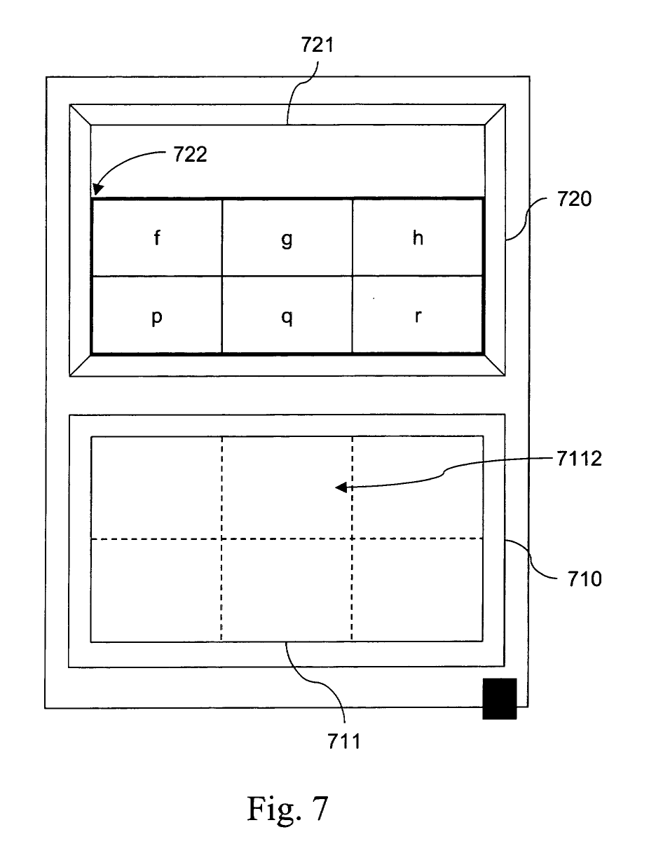

Then the operation and method of the device of the present invention is illustrated by the second embodiment, which takes a mobile phone 700 having a touch PAD 710 as an example. As shown in FIG. 7, when the user intends to input an English letter “g” with the present invention, the mobile phone 700 first produces a table 400b in the memory 210, and allocates the English letters and Arabic numerals in the table 400b as shown in FIG. 4B (Step 310). Then the processor 220 in the mobile phone defines a display region 721 on a screen 720 to display a table 722 of 3×2 (Step 320). At this time, the user continuously lines out a rightward track with the finger in the input region 711 on the touch PAD 710 to input a move signal (Step 330), until the table 722 in the display region 721 on the screen 720 displays the character “g”. When the processor 220 receives a rightward move signal, the table 400b is displaced upward, such that the table 722 displayed in the display region 721 on the screen 720 makes a rightward displacement (Step 340). When the character “g” appears in the table 722, the user can click the location 7112 corresponding to the table 722 in the display region 711 of the touch PAD 710 to input the select signal (Step 350). The touch PAD 710 transmits the location clicked by the user to the processor 220, and after receiving the select signal, the processor determines that the field of the table 722 corresponding to the location 7112 clicked by the user is the character “g”, thus “g” is input to the editor of the mobile phone.

Furthermore, the input method of the present invention using slides and clicks can be achieved in hardware, software or a combination thereof, or be achieved in an electronic device in an integral way, or in a distributed way of distributing different components in a plurality of interconnected electronic devices.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An input method using slides and clicks, for inputting characters of at least one language on an electronic device having a display region and an input region, comprising:
producing a first table of M×N larger than the display region and allocating a character set corresponding to the language on the first table;
defining the display region to display a second table of M1×N1, wherein M is larger than M1 and N is larger than N1;
inputting at least one move signal;
displacing the first table based on the move signal, and displaying the part of M1×N1 of the first table in the second table;
inputting a select signal; and
inputting a character corresponding to a field in the second table based on the select signal.

2. The method as claimed in claim 1, wherein the step of inputting the move signal comprises lining out a track on the input region.

3. The method as claimed in claim 1, wherein the step of displacing the first table comprising shifting the table horizontally by a predetermined column number.

4. The method as claimed in claim 3, wherein the predetermined column number is produced by determining the length of the lined out track.

5. The method as claimed in claim 1, wherein the step of displacing the first table comprises shifting the table vertically by a predetermined row number.

6. The method as claimed in claim 5, wherein the predetermined row number is produced by determining the length of the lined out track.

7. The method as claimed in claim 1, wherein the step of displacing the first table comprises shifting the table in a circular way.

8. The method as claimed in claim 1, wherein the step of inputting the move signal comprises performing a pressing action on the input region.

9. An input device using slides and clicks, for inputting characters of at least one language by a display region and an input region, comprising:
a memory, for producing a first table of M×N larger than the display region, wherein the first table is allocated with a character set corresponding to the language;
a processor, coupled with the memory, for defining the display region to display a second table of M1×N1, wherein M is larger than M1 and N is larger than N1;
a display device, coupled with the processor, comprising the display region, for displaying the second table defined by the processor; and
an input device, coupled with the processor, comprising the input region, for inputting at least one move signal and a select signal;
wherein, after the processor receives the move signal, the table is displaced based on the move signal, and the part of M1×N1 of the first table is displayed in the second table by the display region, and after the select signal is received, a character corresponding to a field in the second table is input.

10. The device as claimed in claim 9, wherein the character set comprises phonetic symbols.

11. The device as claimed in claim 9, wherein the character set comprises English letters.

12. The device as claimed in claim 9, wherein the input device is a touch PAD.

13. The device as claimed in claim 9, wherein the input device is a touch screen.

14. The device as claimed in claim 9, wherein the move signal comprises moving the finger on the input region.

15. The device as claimed in claim 9, wherein the select signal comprises pressing the input region.

16. The device as claimed in claim 9, wherein the part of M1×N1 of the first table displayed by the second table is an overlapping range of the first table after being shifted horizontally by a predetermined column number and the displayed part of the second table before being displaced.

17. The device as claimed in claim 16, wherein the predetermined column number is corresponding to the length of the input signal.

18. The device as claimed in claim 9, wherein the part of M1×N1 of the first table displayed by the second table is an overlapping range of the first table after being shifted vertically by a predetermined row number and the displayed part of the second table before being displaced.

19. The device as claimed in claim 18, wherein the predetermined row number is corresponding to the length of the input signal.

20. The device as claimed in claim 9, wherein the table is circularly displayed on the display region.
